(19) United States
(12) Patent Application Publication
(10) Pub. No.: US 2022/0004778 A1
(43) Pub. Date: Jan. 6, 2022

(54) VEHICLE AND VEHICLE CABIN INSIDE-OUTSIDE MONITORING SYSTEM

(71) Applicant: TOYOTA JIDOSHA KABUSHIKI KAISHA, Toyota-shi (JP)

(72) Inventors: Yuta ISHIKO, Nagoya-shi (JP); Masahiro MISAKI, Nagoya-shi (JP)

(73) Assignee: TOYOTA JIDOSHA KABUSHIKI KAISHA, Toyota-shi (JP)

(21) Appl. No.: 17/339,387

(22) Filed: Jun. 4, 2021

(30) Foreign Application Priority Data
Jul. 6, 2020 (JP) 2020-116665

(51) Int. Cl. G06K 9/00; G06T 7/00; B60R 11/04

(52) U.S. Cl. CPC G06K 9/00791; G06K 9/00832; G06T 7/0008; B60R 2011/0003; G06T 2207/30252; G06T 2207/30268; B60R 11/04

(57) ABSTRACT

A first motor is driven to move a camera configured to image an area (imaging area A) in front of a vehicle such that a vehicle cabin inside (imaging area C) is imageable, and a second motor is driven to move a camera configured to image an area (imaging area B) behind the vehicle such that a vehicle cabin inside (imaging area D) is imageable. The swing of the cameras by the motors enables imaging of the vehicle cabin inside with the cameras configured to image the vehicle cabin outside. For this reason, there is no need to prepare a camera that images the vehicle cabin inside, separately from the camera that images the vehicle cabin outside, and thus, it is possible to reduce cost as much.

### CROSS-REFERENCE TO RELATED APPLICATION

This application claims priority to Japanese Patent Application No. 2020-116665 filed on Jul. 6, 2020, incorporated herein by reference in its entirety.

### BACKGROUND

### 1. Technical Field

The present disclosure relates to a vehicle and a vehicle cabin inside-outside monitoring system.

### 2. Description of Related Art

Japanese Unexamined Patent Application Publication No. 2019-167077 discloses a system in which an in-vehicle cabin camera configured to detect a state of dirt in a vehicle cabin inside is mounted in a vehicle and dirt in the vehicle cabin inside is automatically detected by the in-vehicle cabin camera after use of an occupant. In the system, a need for cleaning the vehicle is determined depending on the state of dirt in the vehicle cabin inside, and determination is made whether to automatically perform cleaning with an in-vehicle purifying device or to automatically move the vehicle to a base where cleaning is performed.

### SUMMARY

In the above-described related art, the in-vehicle cabin camera is provided separately from a camera that images an area in front of the vehicle. Accordingly, in the above-described related art, a plurality of cameras is needed, thereby causing an increase in cost of the vehicle as much.

In view of the above-described fact, an object of the disclosure is to expensively obtain a vehicle and a vehicle cabin inside-outside monitoring system capable of confirming a state of an inside of a vehicle cabin after an occupant has used a vehicle.

An aspect of the disclosure relates to a vehicle including an imaging device, a communication unit, and a movement unit. The imaging device is provided in a vehicle cabin inside and configured to image a vehicle cabin outside. The communication unit is configured to transmit and receive a signal or information to and from an outside of the vehicle. The movement unit is configured to enable movement of the imaging device such that an inside of the vehicle cabin is imageable based on the signal or information received by the communication unit.

The vehicle according to the aspect includes the imaging device and the movement unit. The imaging device is provided in the vehicle cabin inside and is configured to image the vehicle cabin outside. On the other hand, the movement unit is configured to enable the movement of the imaging device such that an imaging area of the imaging device is turned from the vehicle cabin outside to the vehicle cabin inside based on the signal or information received by the communication unit configured to transmit and receive the signal or information to and from the outside of the vehicle. That is, according to the aspect of the disclosure, the imaging device is moved through the movement unit based on the signal or information from the outside of the vehicle, and the vehicle cabin inside can be imaged with the imaging device that images the vehicle cabin outside.

In this way, according to the aspect of the disclosure, with the movement of the imaging device by the movement unit, the vehicle cabin inside can be imaged with the imaging device that images the vehicle cabin outside. Thus, there is no need to separately prepare an imaging device that images the vehicle cabin inside, and it is possible to reduce cost as much.

Note that the “movement” used herein is movement that enables imaging of the vehicle cabin inside with the imaging device that images the vehicle cabin outside. Thus, for example, the imaging device swings along a vehicle front-rear direction around a shaft provided along a vehicle width direction. In addition, the imaging device may swing along the vehicle width direction around a shaft provided along a vehicle up-down direction.

In the disclosure, the “signal or information received by the communication unit” includes, for example, a concept that a time to move the imaging device is set in advance and the imaging device is moved based on information, in addition to moving the imaging device in real time by a signal based on a remote operation.

In the vehicle according to the aspect, the movement unit may include a motor provided in at least one of a front end portion and a rear end portion in a vehicle front-rear direction in the vehicle cabin inside and configured to make the imaging device swing along the vehicle front-rear direction around a shaft disposed along a vehicle width direction.

In the vehicle according to the aspect, the movement unit includes the motor. The shaft that is disposed along the vehicle width direction in at least one of the front end portion of the rear end portion in the vehicle front-rear direction in the vehicle cabin inside, and the imaging device is set to swing along the vehicle front-rear direction around the shaft.

Here, when the imaging device is provided in the front end portion in the vehicle front-rear direction in the vehicle cabin inside, an area in front of the vehicle is imaged by the imaging device. Furthermore, when the imaging device is provided in the rear end portion in the vehicle front-rear direction in the vehicle cabin inside, an area behind the vehicle is imaged by the imaging device. In addition, when the imaging devices are provided in the front end portion and the rear end portion in the vehicle front-rear direction in the vehicle cabin inside, the area in front of the vehicle is imaged by the imaging device provided in the front end portion in the vehicle front-rear direction in the vehicle cabin inside, and the area behind the vehicle is imaged by the imaging device provided in the rear end portion in the vehicle front-rear direction in the vehicle cabin inside.

In the vehicle according to the aspect, when an occupant is using the vehicle, an imaging area of the imaging device may be the vehicle cabin outside. In a case where the occupant ends the use of the vehicle, the motor may be driven based on the signal or information received by the communication unit and the imaging area of the imaging device may be turned to the vehicle cabin inside.

In the vehicle according to the aspect, when the occupant is using the vehicle, the imaging area of the imaging device is the vehicle cabin outside. With this, according to the aspect of the disclosure, for example, when the occupant is on the vehicle, the vehicle cabin outside is imaged and can be used as a drive recorder. Furthermore, the occupant is restrained from being imaged when the occupant is on the vehicle, whereby it is possible to secure the privacy of the occupant.

On the other hand, according to the aspect of the disclosure, in a case where the occupant ends the use of the vehicle, the motor is driven based on the signal or information received by the communication unit, and the imaging area of the imaging device is turned to the vehicle cabin inside. With this, it is possible to detect a thing left behind of the occupant, or the like.

In the vehicle according to the aspect, the vehicle cabin inside may be imaged with the imaging device to acquire first image information based on the signal or information received by the communication unit before the occupant uses the vehicle, and the vehicle cabin inside may be imaged with the imaging device to acquire second image information based on the signal or information received by the communication unit after the occupant has used the vehicle.

In the vehicle according to the aspect, the first image information obtained by imaging the vehicle cabin inside with the imaging device before the occupant uses the vehicle (before vehicle use of the occupant) and the second image information obtained by imaging the vehicle cabin inside with the imaging device after the occupant has used the vehicle (after vehicle use of the occupant) are acquired based on the signal or information received by the communication unit.

With this, for example, when an article that is not present in the first image information is present in the second image information, determination is made that the article is a thing left behind of the occupant. Furthermore, when scratch or dirt that is not present in the first image information is present in the second image information, determination is made that scratch or dirt occurs during the use of the vehicle.

The vehicle according to the aspect may further include a difference detection unit configured to detect a difference between the first image information and the second image information.

The vehicle according to the aspect further includes the difference detection unit, and with the difference detection unit, it is possible to detect the difference between the first image information of the vehicle cabin inside imaged before the vehicle use of the occupant and the second image information of the vehicle cabin inside imaged after the vehicle use of the occupant. That is, according to the aspect of the disclosure, the presence or absence of a thing left behind of the occupant, scratch, dirt is detected by the difference detection unit.

In the vehicle according to the aspect, the difference may include an article, scratch, and dirt.

In the vehicle according to the aspect of the disclosure, the difference between the first image information of the vehicle cabin inside imaged before the vehicle use of the occupant and the second image information of the vehicle cabin inside imaged after the vehicle use of the occupant is detected, whereby it is possible to the presence or absence of a thing left behind of the occupant who has used the vehicle, the presence or absence of scratch or the presence or absence of dirt that occurs during the use of the vehicle, or the like.

Another aspect of the disclosure relates to a vehicle cabin inside-outside monitoring system including the vehicle according to the aspect, and a server. The server is configured to receive, through a network, first image information obtained by imaging a vehicle cabin inside with the imaging device before an occupant uses the vehicle and second image information obtained by imaging the vehicle cabin inside with the imaging device after the occupant has used the vehicle.

The vehicle cabin inside-outside monitoring system of the aspect includes the vehicle and the server. In the vehicle, with the movement of the imaging device by the movement unit, the vehicle cabin inside can be imaged with the imaging device that images the vehicle cabin outside. Thus, there is no need to separately prepare an imaging device that images the vehicle cabin inside, and it is possible to reduce cost as much. The server receives the first image information of the vehicle cabin inside imaged before the vehicle use of the occupant and the second image information of the vehicle cabin inside imaged after the vehicle use of the occupant through the network.

In the vehicle cabin inside-outside monitoring system according to the aspect, the server may include a difference detection unit configured to detect a difference between the first image information and the second image information.

In the vehicle cabin inside-outside monitoring system according to the aspect, the server includes the difference detection unit, and the difference between the first image information of the vehicle cabin inside imaged before the vehicle use of the occupant and the second image information of the vehicle cabin inside imaged after the vehicle use of the occupant is detected by the server.

In the vehicle cabin inside-outside monitoring system according to the aspect, the difference detection unit may be configured to create difference image information representing an image that specifies the difference.

In the vehicle cabin inside-outside monitoring system according to the aspect, the difference image information representing the image that specifies the difference between the first image information of the vehicle cabin inside imaged before the vehicle use of the occupant and the second image information of the vehicle cabin inside imaged after the vehicle use of the occupant is created by the difference detection unit. That is, the difference between the first image information and the second image information is specified as an image by the difference image information. For this reason, it is possible to allow a manager to determine the presence or absence of continuation of the use of the vehicle based on the image.

In the vehicle cabin inside-outside monitoring system according to the aspect, the vehicle may be shared by a plurality of users and is used by each user at a different time.

In the vehicle cabin inside-outside monitoring system according to the aspect, the vehicle is shared by the users and is used by each user at a different time, and is used in, for example, a car sharing service.

As described above, the vehicle according to the aspect has an excellent effect that it is possible to expensively realize confirmation of a state of the vehicle cabin inside after the occupant has used the vehicle.

The vehicle according to the aspect has an excellent effect that it is possible to make the imaging device swing along the vehicle front-rear direction around the shaft provided along the vehicle width direction.

The vehicle according to the aspect has an excellent effect that it is possible to secure the privacy of the occupant when the occupant is on the vehicle, and to detect a thing left behind of the occupant after the occupant has used the vehicle.

The vehicle according to the aspect has an excellent effect that it is possible to determine the presence or absence of a thing left behind of the occupant, scratch, dirt, or the like.

The vehicle according to the aspect has an excellent effect that, with the difference detection unit, it is possible to detect the difference of the vehicle cabin inside before the occupant uses the vehicle and after the occupant has used the vehicle.

The vehicle according to the aspect has an excellent effect that it is possible to detect the presence or absence of a thing left behind of the occupant, the presence or absence of scratch, the presence or absence of dirt, or the like.

The vehicle cabin inside-outside monitoring system according to the aspect has an excellent effect that it is possible to expensively realize confirmation of a state of the vehicle cabin inside after the occupant has used the vehicle.

The vehicle cabin inside-outside monitoring system according to the aspect has an excellent effect that it is possible to detect the difference between the first image information and the second image information in the server.

The vehicle cabin inside-outside monitoring system according to the aspect has an excellent effect that it is possible to allow the manager to determine the presence or absence of continuation of the use of the vehicle based on the image where the difference between the first image information and the second image information is specified.

The vehicle cabin inside-outside monitoring system according to the aspect has an excellent effect that it is possible to use the system in a car sharing service.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a vehicle cabin inside-outside monitoring system according to an embodiment;

FIG. 2 is a schematic side view showing a state in which a vehicle cabin inside of a vehicle according to the embodiment is looked through;

FIG. 3 is a schematic plan view showing a state in which the vehicle cabin inside of the vehicle according to the embodiment is looked through;

FIG. 4 is a schematic sectional view showing a movement unit of a camera provided in the vehicle according to the embodiment;

FIG. 5 is a block diagram showing the configuration of a controller of a vehicle cabin inside detection device that constitutes a part of the vehicle cabin inside-outside monitoring system according to the embodiment;

FIG. 6 is a block diagram showing the configuration of a controller of a cloud server that constitutes a part of the vehicle cabin inside-outside monitoring system according to the embodiment;

FIG. 7 is a block diagram showing the configuration of a controller of a management server that constitutes a part of the vehicle cabin inside-outside monitoring system according to the embodiment;

FIG. 8 is a block diagram showing the functional configuration of the vehicle cabin inside detection device that constitutes a part of the vehicle cabin inside-outside monitoring system according to the embodiment;

FIG. 9 is a block diagram showing the functional configuration of the cloud server that constitutes a part of the vehicle cabin inside-outside monitoring system according to the embodiment;

FIG. 10 is a block diagram showing the functional configuration of the management server that constitutes a part of the vehicle cabin inside-outside monitoring system according to the embodiment;

FIG. 11 is a flowchart showing a flow of processing on the vehicle side before an occupant uses the vehicle as an example of difference detection processing by the vehicle cabin inside-outside monitoring system according to the embodiment;

FIG. 12 is a flowchart showing a flow of processing on the vehicle side after the occupant has used the vehicle as an example of the difference detection processing by the vehicle cabin inside-outside monitoring system according to the embodiment;

FIG. 13 is a flowchart showing a flow of processing of the cloud server as an example of the difference detection processing by the vehicle cabin inside-outside monitoring system according to the embodiment; and

FIG. 14 is a flowchart showing a flow of processing of the management server as an example of the difference detection processing by the vehicle cabin inside-outside monitoring system according to the embodiment.

### DETAILED DESCRIPTION OF EMBODIMENTS

A vehicle cabin inside-outside monitoring system according to an embodiment will be described referring to the drawings.

Configuration of Vehicle Cabin Inside-Outside Monitoring System

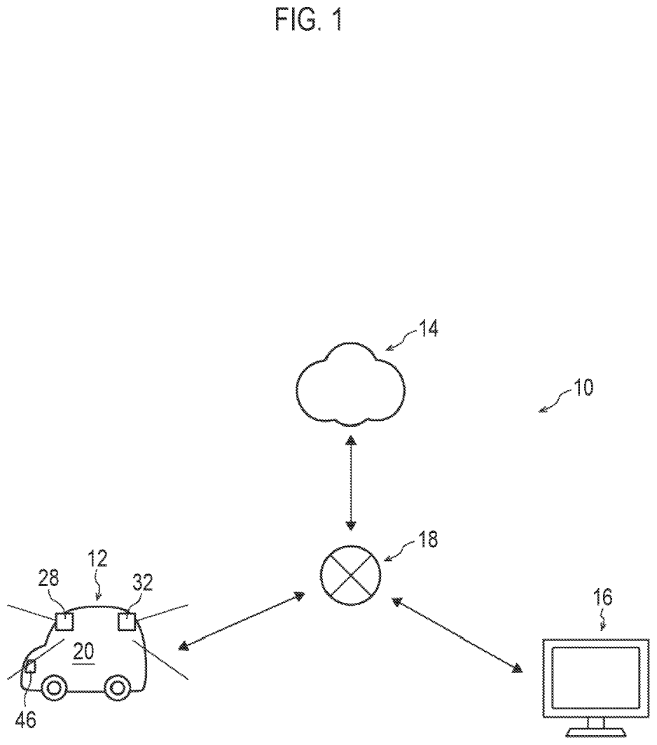

FIG. 1 is a conceptual diagram of a vehicle cabin inside-outside monitoring system 10 according to the embodiment.

As shown in the drawing, the vehicle cabin inside-outside monitoring system 10 of the embodiment includes, for example, a vehicle 12, a cloud server (vehicle outside) 14, and a management server (vehicle outside) 16, and the vehicle 12, the cloud server 14, and the management server 16 are connected by a predetermined network 18.

In the embodiment, as an example, the vehicle 12 is a vehicle that is used in a car sharing service. For this reason, a user who uses the car sharing service can use the vehicle 12 by making a reservation of the vehicle 12, and the reservation made by the user is managed by the management server 16. Note that information regarding the usable vehicle 12 is accumulated from the management server 16 into the cloud server 14 through the network 18, and information of the vehicle 12 is updated regularly.

Configuration of Vehicle

Here, the configuration of the vehicle 12 according to the embodiment will be described.

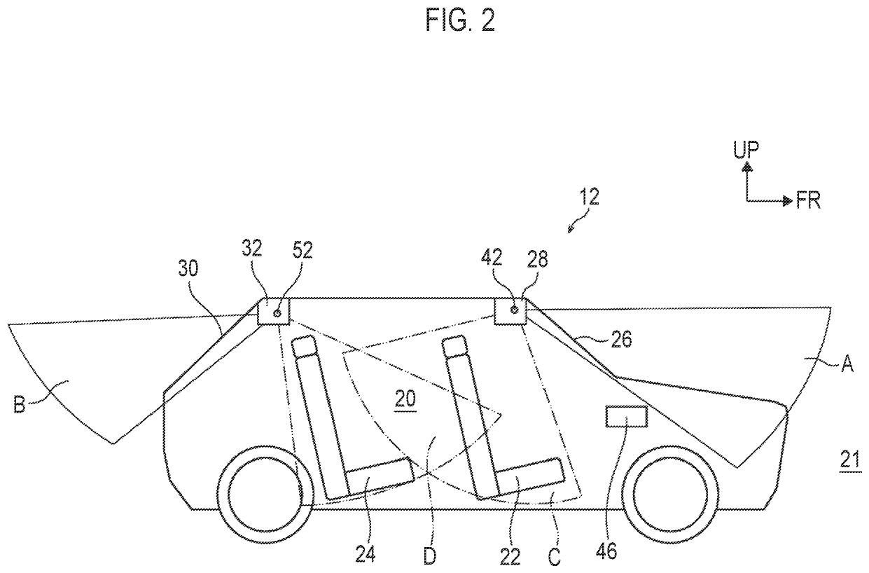

Note that an arrow FR, an arrow UP, an arrow LH, and an arrow RH that are illustrated appropriately in FIGS. 2 to 4 indicate a forward direction (moving direction), an upward direction, a leftward direction in a width direction, and a rightward direction in the width direction of an automobile (vehicle) 12, respectively. Hereinafter, when description is provided using front-rear, up-down, and right-left directions, these directions indicate front and rear in the vehicle front-rear direction, upper and lower sides in the vehicle up-down direction, and right and left in the vehicle right-left direction (vehicle width direction) unless otherwise specified. Furthermore, in the embodiment, for convenience of description, the vehicle 12 does not indicate a specific vehicle but indicates usable vehicles in general, and a host vehicle and a non-host vehicle will be described using the same reference numeral without distinction.

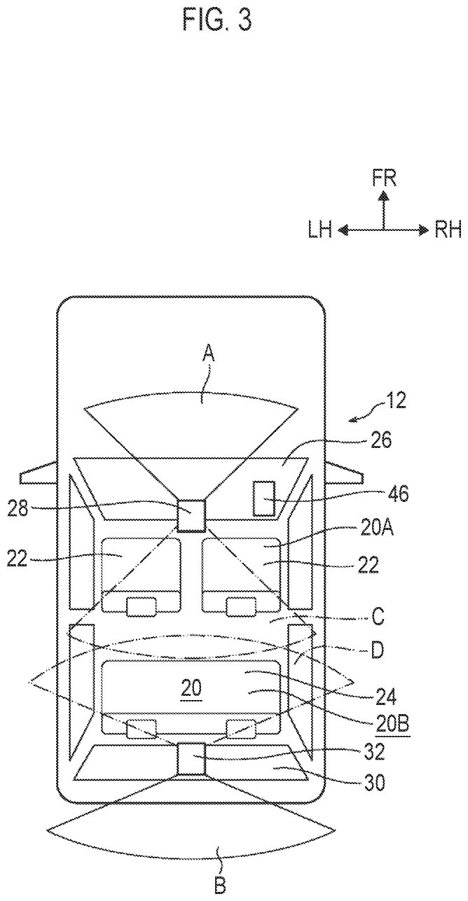

FIG. 2 is a schematic side view of the vehicle 12 in a state in which a vehicle cabin inside 20 is looked through, and FIG. 3 is a schematic plan view of the vehicle 12 in a state in which the vehicle cabin inside 20 is looked through.

As shown in FIGS. 2 and 3, in the vehicle cabin inside 20 of the vehicle 12, a front seat 22 is provided along the vehicle width direction in a front portion 20A in the vehicle front-rear direction, and a rear seat 24 is provided along the vehicle width direction in a rear portion 20B in the vehicle front-rear direction. An occupant can seat on each of the front seat 22 and the rear seat 24. Note that the vehicle 12 is a so-called two-row seat vehicle, but is not limited thereto and may be a vehicle of a different seat type, such as three-row seat vehicle.

On the other hand, a camera (imaging device) 28 is provided on an upper end side in the vehicle up-down direction and a center side in the vehicle width direction of a front windshield (a front end portion in the vehicle front-rear direction in the vehicle cabin inside) 26 in the vehicle cabin inside 20. Note that the camera 28 can image a vehicle cabin outside 21, that is, an area in front of the vehicle (an imaging area including an area A indicated in a substantially conical shape by a solid line).

Furthermore, a camera (imaging device) 32 is provided on an upper end side in the vehicle up-down direction and a center side in the vehicle width direction of a rear windshield (a rear end portion in the vehicle front-rear direction in the vehicle cabin inside) 30 in the vehicle cabin inside 20. Note that the camera 32 can image the vehicle cabin outside 21, that is, an area behind the vehicle (an imaging area including an area B indicated in a substantially conical shape by a solid line).

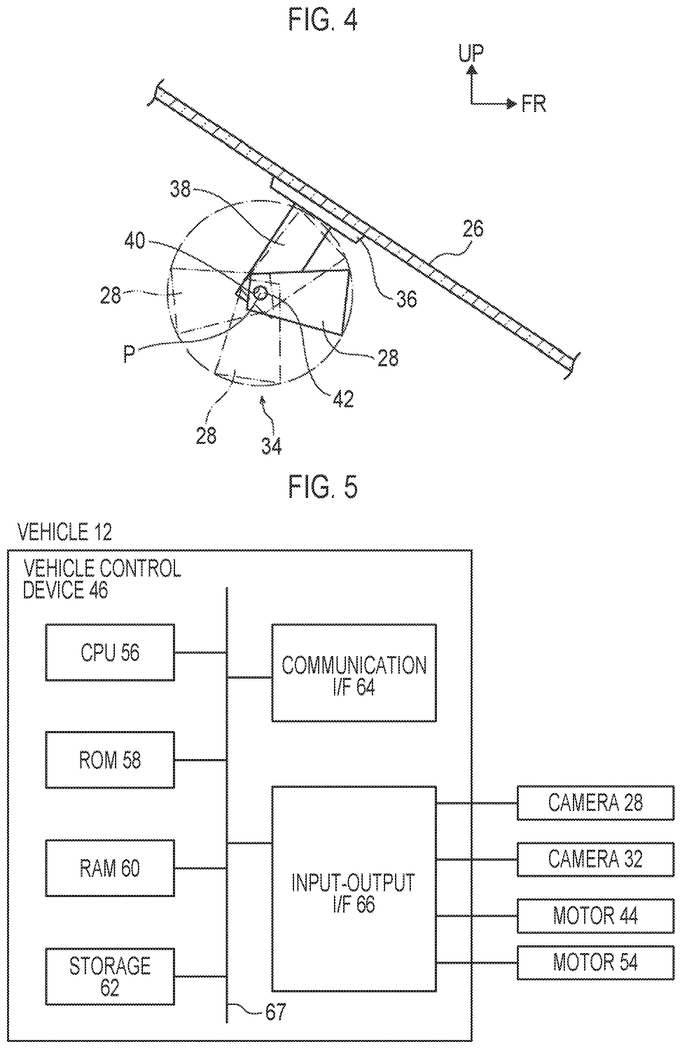

Here, FIG. 4 is a schematic side sectional view showing a swing operation of the camera 28. As shown in the drawing, in the embodiment, for example, a pedestal 36 is attached to the front windshield 26. The pedestal 36 is provided with a pair of bearing plates 38 facing in the vehicle width direction, and bearing holes 40 are formed in the bearing plates 38, respectively. A shaft 42 that constitutes a part of a movement unit 34 can be inserted into the bearing holes 40. The shaft 42 has a diameter smaller than the bearing holes 40, is disposed along the vehicle width direction in a state supported by the bearing holes 40, and can rotate around the bearing holes 40.

On the other hand, for example, a shaft hole (not shown) into which the shaft 42 can be fitted is formed in the camera 28, and the shaft 42 is fitted into the shaft hole. With this, the shaft 42 and the camera 28 are integrated, and the camera 28 can swing around an axis P passing through the center of the bearing hole 40.

A motor 44 (see FIG. 5) that constitutes another part of the movement unit 34 is coupled to the shaft 42 through a gear (not shown). The motor 44 can rotate in a forward or reverse direction, and with the drive of the motor 44, the shaft 42 rotates in a forward or reverse direction through the gear. In this way, in a case where the shaft 42 rotates, the camera 28 swings along the vehicle front-rear direction along with the shaft 42.

That is, as shown in FIGS. 2 and 3, the camera 28 that images an area in front of the vehicle swings toward the rear side in the vehicle front-rear direction around the shaft 42 (strictly, the axis P) with the drive of the motor 44. With this, the camera 28 can image the vehicle cabin inside 20 (an imaging area including an area C indicated in a substantially conical shape by a two-dot chain line) primarily including the front seat 22 side.

Furthermore, though not shown in the drawing, like the front windshield 26, a pedestal is attached to the rear windshield 30, and the pedestal is provided with a pair of bearing plates facing in the vehicle width direction. A shaft 52 (see FIG. 2) that constituting a part of the movement unit 34 is provided in the bearing plates, and the camera 32 can swing integrally with the shaft 52.

A motor 54 (see FIG. 5) that constitutes another part of the movement unit 34 is coupled to the shaft 52 through a gear (not shown). The motor 54 can rotate in a forward or reverse direction, and with the drive of the motor 54, the shaft 52 rotates in a forward or reverse direction through the gear. In this way, in a case where the shaft 52 rotates, the camera 32 swings along the vehicle front-rear direction along with the shaft 52.

That is, the camera 32 that images an area behind the vehicle swings toward a front side in the vehicle front-rear direction around the shaft 52 with the drive of the motor 54. With this, the camera 32 can image the vehicle cabin inside 20 (an imaging area including an area D indicated in a substantially conical shape by a two-dot chain line) primarily including the rear seat 24 side.

Note that the imaging area (including the area C) on the vehicle cabin inside 20 imaged by the camera 28 and the imaging area (including the area D) on the vehicle cabin inside 20 imaged by the camera 32 overlap partially, and are set such that a blind area does not occur.

Configuration of Vehicle Control Device of Vehicle

FIG. 5 is a block diagram showing the configuration of a vehicle control device 46 of the vehicle 12 including hardware.

As shown in FIG. 5, the vehicle control device 46 of the vehicle 12 includes a central processing unit (CPU) 56, a read only memory (ROM) 58, a random access memory (RAM) 60, a storage 62, a communication interface (communication I/F; communication unit) 64, and an input-output interface (input-output I/F) 66. Note that the respective configurations are connected in a communicable manner through a bus 67.

The CPU 56 is a central processing unit, and executes various programs and controls respective units. The ROM 58 stores various programs and various kinds of data. The RAM 60 temporarily stores a program or data as a work area. The storage 62 is constituted of a hard disk drive (HDD) or a solid state drive (SSD), and stores various programs including an operating system and various kinds of data.

That is, the CPU 56 reads a program from the ROM 58 or the storage 62 and executes the program using the RAM 60 as a work area. The CPU 56 controls the above-described respective configurations and executes various kinds of arithmetic processing according to the programs recorded in the ROM 58 or the storage 62.

Note that, in the embodiment, the ROM 58 or the storage 62 stores, for example, a program for imaging the vehicle cabin inside 20 with the cameras 28, 32 to acquire image information A (first image information) before an occupant uses the vehicle 12 (before vehicle use) or imaging the vehicle cabin inside 20 with the cameras 28, 32 to acquire image information B (second image information) after the occupant has used the vehicle 12 (after vehicle use) like. That is, processing of acquiring the image information A and the image information B is executed by the CPU 56 reading a before-vehicle use imaging program and an after-vehicle use imaging program from the ROM 58 or the storage 62 and developing the programs to the RAM 60, respectively.

The communication I/F 64 is an interface that allows the vehicle control device 46 to perform communication with the cloud server 14 and the management server 16 shown in FIG. 1, and other kinds of equipment, and for example, a standard, such as Ethernet (Registered Trademark), FDDI, or Wi-Fi (Registered Trademark), is used.

The cameras 28, 32 and the motors 44, 54 are connected to the input-output I/F 66. The motors 44, 54 are driven by a signal (hereinafter, referred to as a “motor drive signal”) that is input from the management server 16 shown in FIG. 1 to drive the motors 44, 54. The cameras 28, 32 swing with the drive of the motors 44, 54, respectively, and the vehicle cabin inside 20 can be imaged with the cameras 28, 32.

Configuration of Controller of Cloud Server

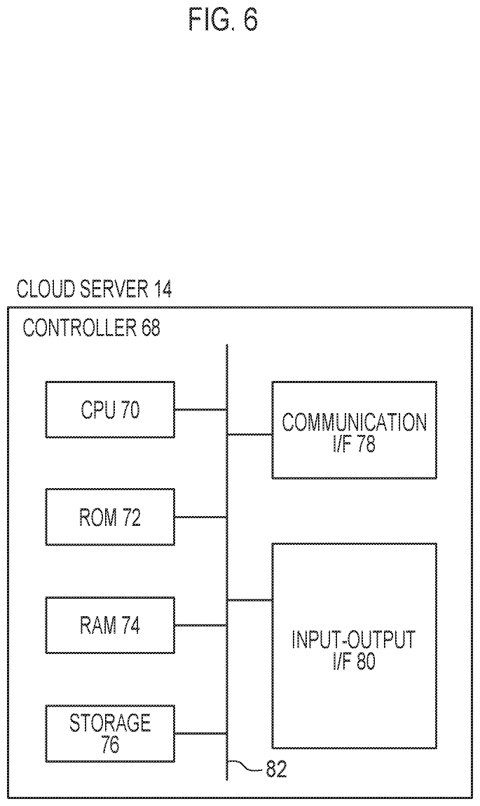

FIG. 6 is a block diagram showing the configuration of a controller 68 of the cloud server 14.

As shown in FIG. 6, the controller 68 of the cloud server 14 includes a CPU 70, a ROM 72, a RAM 74, a storage 76, a communication I/F 78, and an input-output I/F 80. Note that the respective configurations are connected in a communicable manner through a bus 82.

Like the CPU 56 (see FIG. 5), the CPU 70 executes various programs and controls respective units. The ROM 72 stores various programs and various kinds of data. The RAM 74 temporarily stores a program or data as a work area. The storage 76 is constituted of an HDD or an SSD, and stores various programs including an operating system and various kinds of data.

That is, the CPU 70 reads a program from the ROM 72 or the storage 76 and executes the program using the RAM 74 as a work area. The CPU 70 controls the above-described respective configurations and executes various kinds of arithmetic processing according to the program recorded in the ROM 72 or the storage 76.

Note that, in the embodiment, the ROM 72 or the storage 76 stores a difference detection program that detects a difference (difference image information) C in the vehicle cabin inside 20 between the image information A and the image information B, or the like. That is, processing of detecting the difference C is executed by the CPU 70 reading the difference detection program from the ROM 72 or the storage 76 and developing the difference detection program to the RAM 74.

The communication I/F 78 is an interface that allows the cloud server 14 to perform communication with the vehicle control device 46 and the management server 16 shown in FIG. 1, and other kinds of equipment, and like the communication I/F 64 (see FIG. 5), for example, a standard, such as Ethernet, FDDI, or Wi-Fi, is used.

The input-output I/F 80 can transmit and receive a signal or information to and from the vehicle control device 46 and the management server 16 shown in FIG. 1 through the communication I/F 78. For example, the image information A and the image information B can be received from the vehicle control device 46, and information regarding the image information A, the image information B, and the difference C can be transmitted to the management server 16.

Configuration of Controller of Management Server

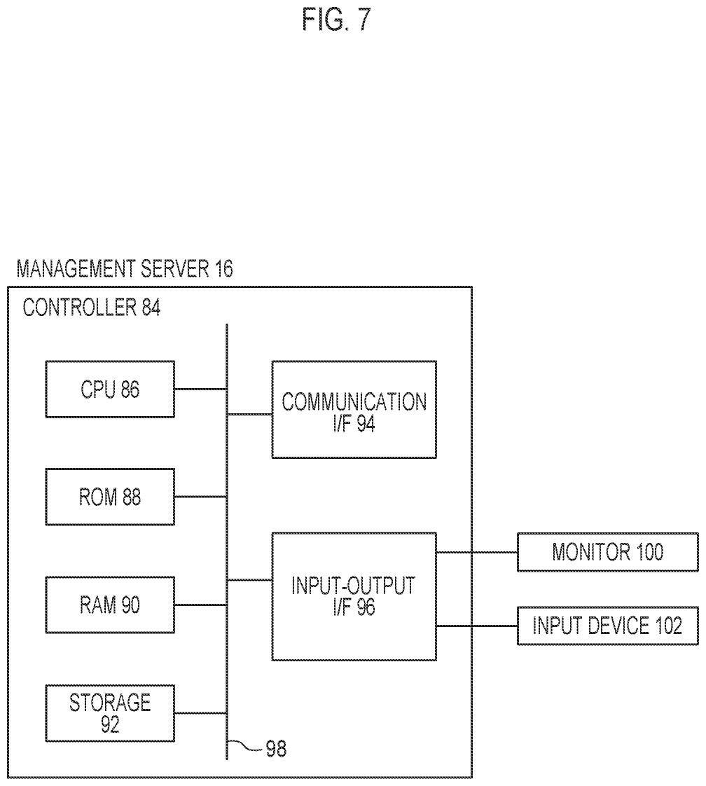

FIG. 7 is a block diagram showing the configuration of a controller 84 of the management server 16 including hardware.

As shown in FIG. 7, the controller 84 of the management server 16 includes a CPU 86, a ROM 88, a RAM 90, a storage 92, a communication I/F 94, and an input-output I/F 96. Note that the respective configurations are connected in a communicable manner through a bus 98.

Like the CPU 56 (see FIG. 5), the CPU 86 is a central processing unit, and executes various programs and controls respective units. The ROM 88 stores various programs and various kinds of data. The RAM 90 temporarily stores a program or data as a work area. The storage 92 is constituted of an HDD or an SSD, and stores various programs including an operating system and various kinds of data.

That is, the CPU 86 reads a program from the ROM 88 or the storage 92, and executes the program using the RAM 90 as a work area. The CPU 86 controls the above-described respective configurations and executes various kinds of arithmetic processing according to the program recorded in the ROM 88 or the storage 92.

The communication I/F 94 is an interface that allows the management server 16 to perform communication with the vehicle control device 46 and the cloud server 14 shown in FIG. 1, and other kinds of equipment, and like the communication I/F 64 (see FIG. 5), for example, a standard, such as Ethernet, FDDI, or Wi-Fi, is used.

A monitor 100 and an input device 102 are connected to the input-output I/F 96. For example, the monitor 100 allows a manager to confirm information (image) of the vehicle cabin inside 20 in each vehicle 12, and information regarding scratch, dirt, or the like in the vehicle cabin inside 20 can be confirmed. On the other hand, the input device 102 is a device that is provided for the manager to perform an input, is constituted of a keyboard, a mouse, a touch panel, and the like, and the motor drive signal is transmitted by an input through the input device 102.

Functional Configuration of Vehicle Control Device 46

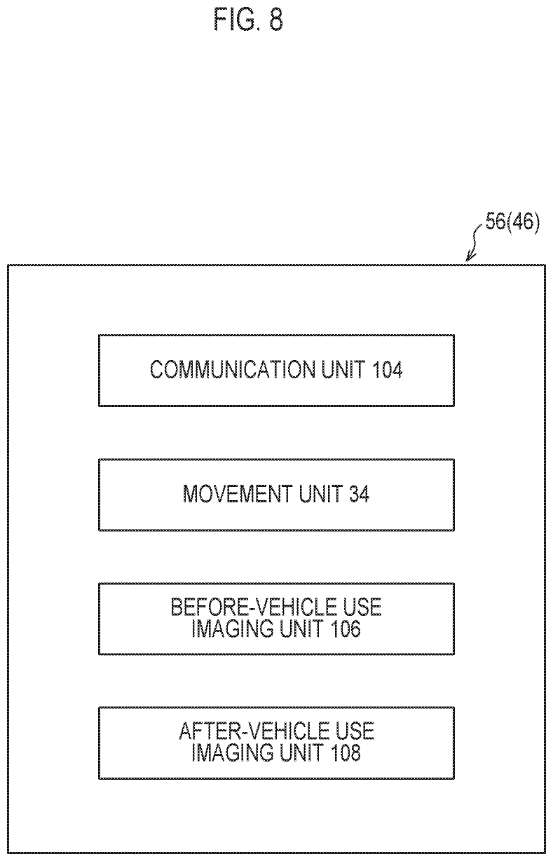

The vehicle control device 46 of the vehicle 12 that constitutes a part of the vehicle cabin inside-outside monitoring system 10 (see FIG. 1) according to the embodiment realizes various functions using the above-described hardware resources. The functional configuration that is realized by the vehicle control device 46 will be described referring to FIGS. 1, 5, and 8. FIG. 8 shows the functional configuration of the vehicle control device 46.

The vehicle control device 46 includes, as the functional configuration, a communication unit 104, a movement unit 34, a before-vehicle use imaging unit 106, and an after-vehicle use imaging unit 108. Note that the functional configuration is realized by the CPU 56 reading the program stored in the ROM 58 or the storage 62 and executing the program.

The communication unit 104 performs communication with the cloud server 14 and the management server 16 through the network 18 shown in FIG. 1 by the communication I/F 64.

For example, the communication unit 104 receives information regarding a time at which that the vehicle 12 is used by car sharing, that is, a use start time and a use end time of the vehicle 12 from the management server 16 through the network 18. The use start time and the use end time of the vehicle 12 are times that are input by the user in advance when reserving the vehicle 12, and information input by the user is accumulated in the management server 16. The communication unit 104 can receive the motor drive signal input by the input device 102 (see FIG. 7) connected to the management server 16. In addition, the communication unit 104 can transmit the image information A and the image information B to the cloud server 14.

In a case where the motor drive signal is received by the communication unit 104, the movement unit 34 drives the motors 44, 54 to make the cameras 28, 32 swing along the vehicle front-rear direction such that the vehicle cabin inside 20 is imageable. The camera 28 is made to swing toward the rear side in the vehicle front-rear direction, and the camera 32 is made to swing toward the front side in the vehicle front-rear direction. That is, the cameras 28, 32 are made to swing such that the vehicle cabin inside 20 is imageable.

The before-vehicle use imaging unit 106 images the vehicle cabin inside 20 before the vehicle use of the occupant. In a case where information regarding the use start time of the vehicle 12 is received by the communication unit 104, the motors 44, 54 are driven, for example, one hour before the use time based on the received information, and the cameras 28, 32 swing to image the vehicle cabin inside 20 (image information A). Then, the image information A imaged in such a manner is transmitted to the cloud server 14 by the communication unit 104.

The after-vehicle use imaging unit 108 images the vehicle cabin inside 20 after the vehicle use of the occupant. For example, in a case where information regarding the use end of the vehicle 12 is actually received by the communication unit 104, the motors 44, 54 are driven in advance (for example, within ten minutes), and the cameras 28, 32 swing to image the vehicle cabin inside 20 (image information B). Then, like the image information A, the image information B imaged in such a manner is transmitted to the cloud server 14 by the communication unit 104.

Functional Configuration of Cloud Server 14

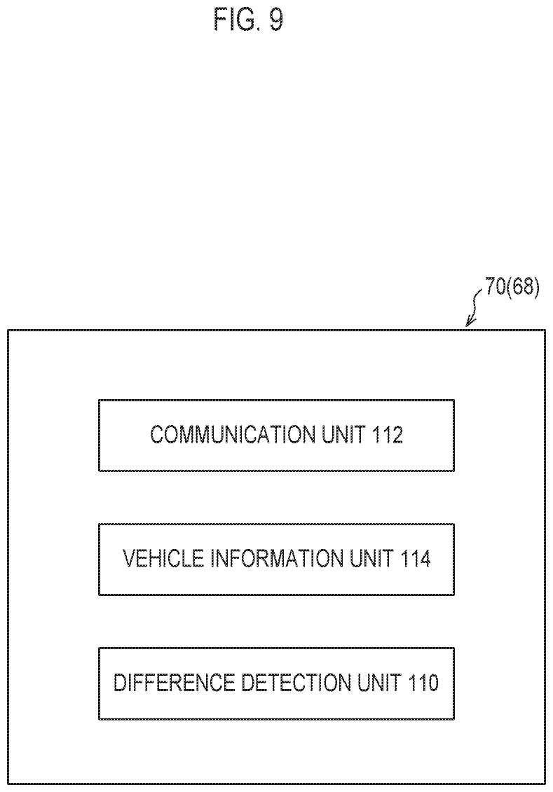

The cloud server 14 that constitutes a part of the vehicle cabin inside-outside monitoring system 10 realizes various functions. The functional configuration that is realized by the cloud server 14 will be described referring to FIGS. 1, 6, and 9. FIG. 9 shows the functional configuration of the cloud server 14.

A controller 68 of the cloud server 14 includes, as the functional configuration, a communication unit 112, a vehicle information unit 114, and a difference detection unit 110.

The communication unit 112 performs communication with the vehicle control device 46 and the management server 16 through the network 18 shown in FIG. 1 by the communication I/F 78. For example, the communication unit 112 receives information (image information A and image information B) from the vehicle control device 46 and transmits information to the management server 16 through the network 18.

In the vehicle information unit 114, for example, a list of usable vehicles 12 and information regarding scratch and dirt of vehicle cabin inside 20 in each the vehicle 12 are accumulated. Here, information regarding scratch and dirt in the vehicle cabin inside 20 in each vehicle 12 is detected by the difference detection unit 110.

The difference detection unit 110 compares the image information A of the vehicle cabin inside 20 imaged by the function of the before-vehicle use imaging unit 106 with the image information B of the vehicle cabin inside 20 imaged by the function of the after-vehicle use imaging unit 108 and extracts the difference C, thereby detecting a thing left behind, scratch, dirt, or the like in the vehicle cabin inside 20 caused by the use of the vehicle 12.

For example, when the use of the vehicle 12 by the user ends, the difference detection unit 110 compares the image information A of the vehicle cabin inside 20 before the use start of the vehicle 12 and the image information B of the vehicle cabin inside 20 after the use end of the vehicle 12 accumulated in the cloud server 14. That is, the difference detection unit 110 detects the presence or absence of a thing left behind in the vehicle cabin inside 20 by extracting and analyzing a changed portion (difference C) from both images (image information A and image information B).

Furthermore, the presence or absence of a place where scratch or dirt newly sticks is detected by the same method as in a case of detecting the presence or absence of a thing left behind. Then, information (image information A, image information B, and difference C) regarding changes of a thing left behind, scratch, and dirt in the vehicle cabin inside 20 is transmitted to the management server 16 through the difference detection unit 110 and the network 18. Note that the image information A, the image information B, and the difference C are subjected to image processing and are displayed as an image A, an image B, and an image C on the monitor 100 (see FIG. 7) described below.

Functional Configuration of Management Server 16

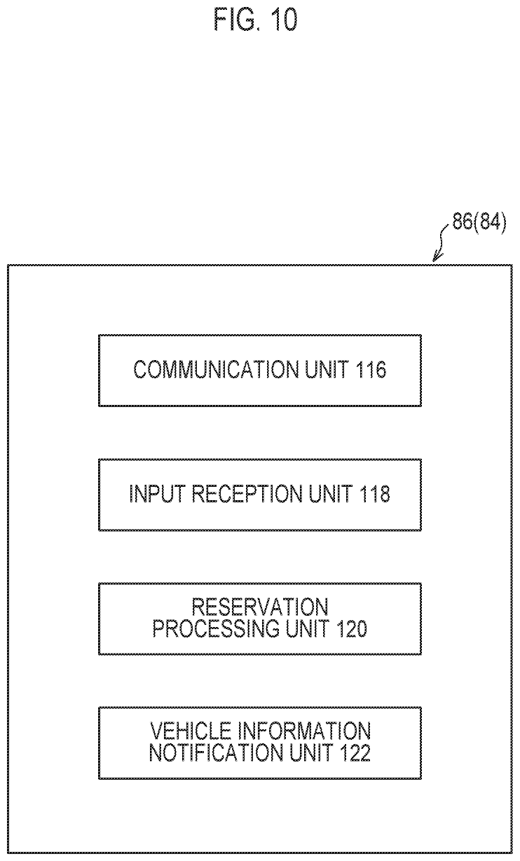

The management server 16 that constitutes a part of the vehicle cabin inside-outside monitoring system 10 realizes various functions using the above-described hardware resources. The functional configuration that is realized by the management server 16 will be described referring to FIGS. 1, 7, and 10. FIG. 10 shows the functional configuration of the management server 16.

A controller 84 of the management server 16 includes, as the functional configuration, a communication unit 116, an input reception unit 118, a reservation processing unit 120, and a vehicle information notification unit 122.

The communication unit 116 performs communication with the vehicle control device 46 and the cloud server 14 through the network 18 shown in FIG. 1 by the communication I/F 94. For example, the communication unit 116 receives information accumulated in the cloud server 14 through the network 18. Furthermore, the communication unit 116 transmits information regarding a reservation to the cloud server 14 through the network 18.

The input reception unit 118 receives information input by the user through the input device 102 or a dedicated application.

When the vehicle 12 is reserved by the user, the reservation processing unit 120 receives the reservation (use start time and use end time) and transmits information regarding the reservation to the vehicle 12 and the cloud server 14.

The vehicle information notification unit 122 displays information of the vehicle 12 on the monitor 100. For example, information is notified to the manager by displaying a list of usable vehicles 12 and information regarding scratch and dirt in the vehicle cabin inside 20 in each vehicle 12. In this case, information regarding scratch and dirt in the vehicle cabin inside 20 in each vehicle 12 is detected by the function of the difference detection unit 110 in the cloud server 14.

Operations and Effects of Vehicle Cabin Inside-Outside Monitoring System

Next, the operations and effects of the vehicle cabin inside-outside monitoring system 10 according to the embodiment will be described.

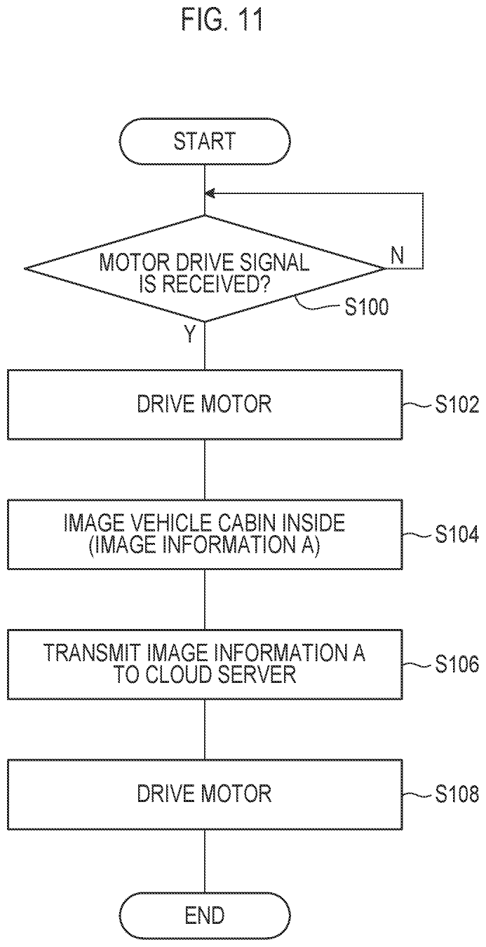

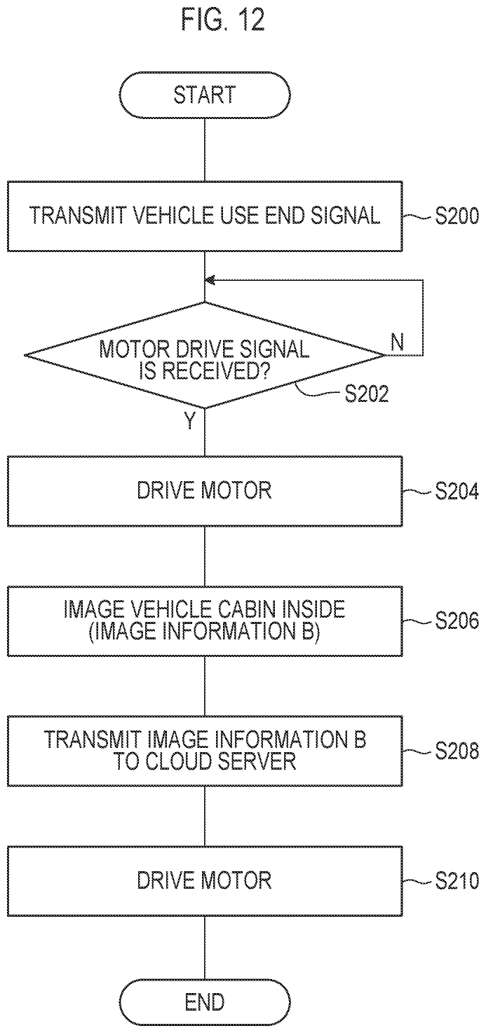

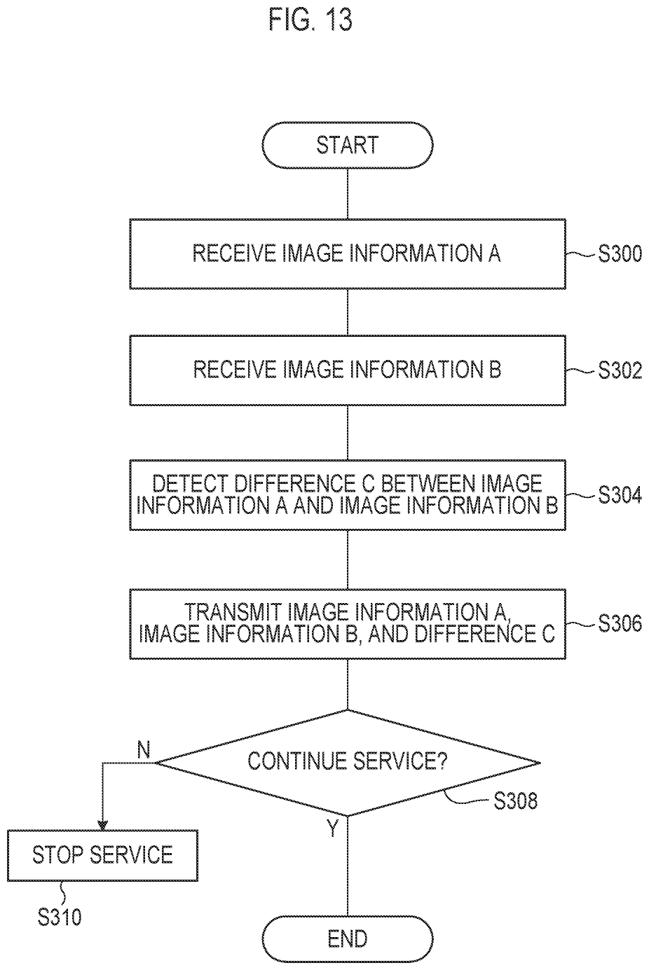

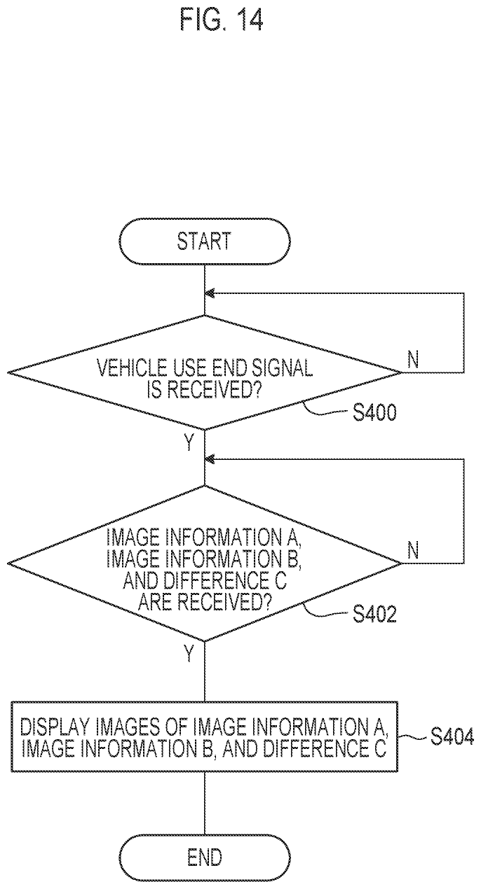

In the following description, a flow of a difference detection processing by the vehicle cabin inside-outside monitoring system 10 will be described along flowcharts of FIGS. 11 to 14. FIG. 11 shows a flow of processing on the vehicle 12 side before the vehicle use of the occupant, and FIG. 12 shows a flow of processing on the vehicle 12 side after the vehicle use of the occupant. FIG. 13 shows a flow of processing of the cloud server 14, and FIG. 14 shows a flow of processing of the management server 16.

Processing State on Vehicle Side Before Vehicle Use

First, a flow of processing on the vehicle side before the vehicle use of the occupant will be described referring to the flowchart shown in FIG. 11 along with FIGS. 1, 5, and 8.

As shown in FIG. 11, in Step S100, the CPU 56 of the vehicle control device 46 determines whether or not the motor drive signal is received. Here, in a case where the motor drive signal is transmitted to the vehicle 12 through the network 18 by an input through the input device 102 of the management server 16 shown in FIG. 7, the CPU 56 receives the motor drive signal by the function of the communication unit 104.

In Step S100, in a case where the motor drive signal is received (Step S100: Y), the CPU 56 progresses processing of Step S102. Note that, in Step S100, the processing is executed until the communication unit 104 receives the motor drive signal.

In Step S102, the CPU 56 drives the motors 44, 54 by the function of the movement unit 34. With this, the cameras 28, 32 swing such that the vehicle cabin inside 20 is imageable.

Specifically, as shown in FIGS. 2 and 3, with the drive of the motor 44, the camera 28 that images the area in front of the vehicle 12 (the imaging area including the area A) swings toward the rear side in the vehicle front-rear direction around the shaft 42. With this, the camera 28 can image the vehicle cabin inside 20 (the imaging area including the area C). Furthermore, with the drive of the motor 54, the camera 32 that images the area behind the vehicle 12 (the imaging area including the area B) swings toward the front side in the vehicle front-rear direction around the shaft 52. With this, the camera 32 can image the vehicle cabin inside 20 (the imaging area including the area D).

In Step S104, the CPU 56 images the vehicle cabin inside 20 with the cameras 28, 32 by the function of the before-vehicle use imaging unit 106 and acquires the image information A of the vehicle cabin inside 20 before the vehicle use.

In Step S106, the CPU 56 transmits the image information A to the cloud server 14 by the function of the communication unit 104.

In Step S108, the CPU 56 drives the motors 44, 54 by the function of the movement unit 34. With this, the cameras 28, 32 swing such that the vehicle cabin outside 21 is imageable.

Specifically, with the drive of the motor 44, the camera 28 that can image the vehicle cabin inside 20 (the imaging area including the area C) swings toward the front side in the vehicle front-rear direction around the shaft 42. With this, the camera 32 can image the area in front of the vehicle (the imaging area including the area A). Furthermore, with the drive of the motor 54, the camera 32 that can image the vehicle cabin inside 20 (the imaging area including the area D) swings toward the rear side in the vehicle front-rear direction around the shaft 52. With this, the camera 32 can image the area behind the vehicle (the imaging area including the area B).

Processing State on Vehicle Side after Vehicle Use

Next, a flow of processing on the vehicle side after the vehicle use of the occupant will be described referring to the flowchart shown in FIG. 12 along with FIGS. 1, 5, and 8.

As shown in FIG. 12, in Step S200, in a case where the use of the vehicle 12 ends, the CPU 56 of the vehicle control device 46 transmits a vehicle use end signal for notifying of the use end of the vehicle 12 to the management server 16 through the network 18. In Step S200, the CPU 56 transmits the vehicle use end signal to the management server 16 by the function of the communication unit 104.

In Step S202, the CPU 56 determines whether or not the motor drive signal is received. Here, in a case where the motor drive signal is transmitted to the vehicle 12 through the network 18 by an input through the input device 102 of the management server 16 shown in FIG. 7, the CPU 56 receives the motor drive signal by the function of the communication unit 104.

In Step S202, in a case where the motor drive signal is received (Step S202: Y), the CPU 56 progresses to processing of Step S204. Note that, in Step S202, the processing is executed until the communication unit 104 receives the motor drive signal.

In Step S204, the CPU 56 drives the motors 44, 54 by the function of the movement unit 34. With this, the cameras 28, 32 swing such that the vehicle cabin inside 20 is imageable.

That is, as shown in FIGS. 2 and 3, with the drive of the motor 44, the camera 28 that images the area in front of the vehicle 12 swings toward the rear side in the vehicle front-rear direction and can image the vehicle cabin inside 20. Furthermore, with the drive of the motor 54, the camera 32 that images the area behind the vehicle 12 swings toward the front side in the vehicle front-rear direction and can image the vehicle cabin inside 20.

In Step S206, the CPU 56 images the vehicle cabin inside 20 with the cameras 28, 32 by the function of the after-vehicle use imaging unit 108 and acquires the image information B of the vehicle cabin inside 20 after the vehicle use.

Note that the image information B is image information imaged by the function of the after-vehicle use imaging unit 108 at the same position and the same angle as the image information A imaged by the above-described before-vehicle use imaging unit 106.

In Step S208, the CPU 56 transmits the image information B to the cloud server 14 by the function of the communication unit 104.

In Step S210, the CPU 56 drives the motors 44, 54 by the function of the movement unit 34. With this, the cameras 28, 32 swing such that the vehicle cabin outside 21 is imageable.

That is, with the drive of the motor 44, the camera 28 that can image the vehicle cabin inside 20 swings toward the front side in the vehicle front-rear direction and can image the area in front of the vehicle. Furthermore, with the drive of the motor 54, the camera 32 that can image the vehicle cabin inside 20 swings toward the rear side in the vehicle front-rear direction and can image the area behind the vehicle.

Processing State on Cloud Server Side

On the other hand, a flow of processing on the cloud server side will be described referring to the flowchart shown in FIG. 13 along with FIGS. 1, 6, and 9.

As shown in FIG. 13, in Step S300, the CPU 70 of the cloud server 14 receives the image information A of the vehicle cabin inside 20 before the vehicle use of the occupant by the function of the communication unit 112.

In Step S302, the CPU 70 receives the image information B of the vehicle cabin inside 20 after the vehicle use of the occupant by the function of the communication unit 112.

In Step S304, the CPU 70 detects the difference C between the image information A and the image information B by the function of the difference detection unit 110. That is, a thing left behind, scratch, dirt, or the like in the vehicle cabin inside 20 caused by the use of the vehicle 12 is detected by extracting the difference C between the image information A and the image information B.

In Step S306, the CPU 70 transmits information regarding the image information A, the image information B, and the difference C to the management server 16 by the function of the communication unit 112.

In Step S306, in a case where information regarding the image information A, the image information B, and the difference C is transmitted to the management server 16, the CPU 70 progresses to processing of Step S308. In Step S308, the CPU 70 determines whether or not the car sharing service can be continued.

Here, the propriety of continuation of the service is realized by, for example, the CPU 70 acquiring a determination result from the management server 16. In this case, in the management server 16, the manager confirms the images based on information regarding the image information A, the image information B, and the difference C. The manager transmits a confirmation result to the cloud server 14, and a result of the propriety of continuation of the service is obtained in the cloud server 14.

Alternatively, the propriety of continuation of the service may be determined based on the difference C by the CPU 70. In this case, the CPU 70 determines a range or a degree of dirt represented as the difference C, and when the range or degree is equal to or greater than a predetermined threshold, determines that the service cannot be continued. In Step S308, when determination is made that the service can be continued (Step S308: Y), the CPU 70 ends the flow.

On the other hand, in Step S308, when determination is made that the service cannot be continued (Step S308: N), the CPU 70 progresses to Step S310. Then, in Step S310, the CPU 70 stops the service of the vehicle 12. Note that the propriety of continuation of the service may be managed in the management server 16 and may not be managed in the cloud server 14. In this case, Steps S308 and S310 can be omitted. Processing State on Management Server Side

A flow of processing on the management server side will be described referring to the flowchart shown in FIG. 14 along with FIGS. 1, 7, and 10.

As shown in FIG. 14, in Step S400, the CPU 86 of the management server 16 determines whether or not the vehicle use end signal for notifying of the use end of the vehicle 12 is received. Here, in Step S200 shown in FIG. 12, the vehicle use end signal is transmitted from the vehicle control device 46 shown in FIG. 5 to the management server 16 through the network 18.

As shown in FIG. 14, in Step S400, in a case where the vehicle use end signal is received by the function of the communication unit 116 (Step S400: Y), the CPU 86 progresses processing of Step S402. Note that, in Step S400, the processing is executed until the communication unit 116 receives the vehicle use end signal.

In Step S402, the CPU 86 determines whether or not information regarding the image information A, the image information B, and the difference C is received. In Step S402, in a case where information regarding the image information A, the image information B, and the difference C is received by the function of the communication unit 116 (Step S402: Y), the CPU 86 progresses to processing of Step S404. Note that, in Step S402, the processing is executed until the communication unit 116 receives information regarding the image information A, the image information B, and the difference C.

In Step S404, the CPU 86 displays the image information A, the image information B, and the difference C on the monitor 100, and progresses processing of Step S406. Note that the image information A, the image information B, and the difference C displayed on the monitor 100 are subjected to image processing and are displayed as the image A, the image B, and the image C, respectively. Here, the CPU 86 may receive an input of a determination result about whether or not the car sharing service can be continued.

Operations and Effects of Vehicle

In the embodiment, as described above, the vehicle 12 shown in FIGS. 2 and 5 includes the cameras 28, 32 that can image the vehicle cabin outside 21, and the motors 44, 54 that constitute a part of the movement unit configured to make the cameras 28, 32 swing along the vehicle front-rear direction.

The motors 44, 54 can be driven based on the motor drive signal received by the function of the communication unit 104 (see FIG. 8), and with the drive of the motors 44, 54, the cameras 28, 32 are moved (swing) such that the imaging areas of the cameras 28, 32 are turned from the vehicle cabin outside 21 to the vehicle cabin inside 20.

In this way, in the embodiment, the swing of the cameras 28, 32 by the motors 44, 54 enables imaging of the vehicle cabin inside 20 with the cameras 28, 32 that image the vehicle cabin outside 21. For this reason, though not shown in the drawing, there is no need to prepare a camera that images the vehicle cabin inside 20, separately from a camera that images the vehicle cabin outside 21, and it is possible to reduce cost as much. That is, in the embodiment, it is possible to expensively confirm the state of the vehicle cabin inside 20 after the vehicle use of the occupant.

In the embodiment, the camera 28 is set to swing along the vehicle front-rear direction around the shaft 42 provided along the vehicle width direction on the front windshield 26 side in the vehicle cabin inside 20, and the camera 32 is set to swing along the vehicle front-rear direction around the shaft 52 provided along the vehicle width direction on the rear windshield 30 side in the vehicle cabin inside 20.

In this way, in the embodiment, the cameras 28, 32 can perform so-called panorama imaging for imaging while swinging along the vehicle front-rear direction. In general, although a fish-eye lens is mounted in a 360° camera because a wide angle of view is obtained, in a case of the fish-eye lens, an image is distorted.

In contrast, in the embodiment, panorama imaging can be performed, whereby it is possible to obtain an image with high image quality, little distortion, and a wide angle of view. An image with a wide angle of view is obtained, whereby it is possible to image a hood provided in the vehicle front portion, and to detect scratch, dirt, or the like of the hood.

In the embodiment, when the occupant is using the vehicle 12, the imaging areas of the cameras 28, 32 are the vehicle cabin outside 21. With this, in the embodiment, when the occupant is on the vehicle, the vehicle cabin outside 21 can be imaged and utilized as a drive recorder. Furthermore, in the embodiment, the occupant is restrained from being imaged when the occupant is on the vehicle, whereby it is possible to secure the privacy of the occupant. On the other hand, in the embodiment, in a case where the occupant ends the use of the vehicle 12, the imaging areas of the cameras 28, 32 are turned to the vehicle cabin inside 20, and with this, it is possible to detect a thing left behind of the occupant, or the like.

That is, in the embodiment, when the occupant is on the vehicle, it is possible to secure the privacy of the occupant, and after the occupant has used the vehicle, it is possible to detect a thing left behind of the occupant, or the like.

Here, in detecting a thing left behind or the like in the vehicle 12, in the embodiment, a setting is performed such that the CPU 70 of the cloud server 14 shown in FIG. 6 detects the difference C between the image information A of the vehicle cabin inside 20 (see FIG. 2) before the vehicle use of the occupant and the image information B of the vehicle cabin inside 20 after the vehicle use of the occupant as shown in FIG. 13.

That is, a thing left behind, scratch, dirt, or the like in the vehicle cabin inside 20 caused by the use of the vehicle 12 (see FIG. 2) is detected by extracting the difference C between the image information A and the image information B. For example, when an article that is not present in the image information A is present in the image information B, determination is made that the article is a thing left behind of the occupant. Furthermore, when scratch or dirt that is not present in the image information A is present in the image information B, determination is made that scratch or dirt occurs during the use of the vehicle.

Information regarding scratch and dirt in the vehicle cabin inside 20 shown in FIG. 2 is displayed on the monitor 100 of the management server 16 shown in FIG. 7, whereby it is possible to allow the user to recognize the state of the vehicle cabin inside 20 in advance, and to suppress the occurrence of trouble.

In the embodiment, in imaging the vehicle cabin outside 21 and the vehicle cabin inside 20 with the cameras 28, 32, the shafts 42, 52 that are provided along the vehicle width direction and the motors 44, 54 that rotate the shafts 42, 52 are provided. That is, in the embodiment, it is possible to change the imaging areas of the cameras 28, 32 with a simple configuration.

In the embodiment, the vehicle 12 is a vehicle that is applied for the car sharing service. For this reason, a setting is performed such that the communication unit 104 on the vehicle 12 side receives the motor drive signal transmitted from the management server 16 after the use end of the vehicle 12, the motors 44, 54 are driven based on the motor drive signal, and the vehicle cabin inside 20 is imaged with the cameras 28, 32, whereby it is possible to detect a thing left behind or the like in the vehicle 12 by a remote operation.

### Supplementary Items of Embodiment

In the embodiment, a setting is performed such that a thing left behind, scratch, dirt, or the like in the vehicle cabin inside 20 caused by the use of the vehicle 12 (see FIG. 2) is detected by the CPU 70 of the cloud server 14 shown in FIG. 6 detecting the difference C between the image information A of the vehicle cabin inside 20 (see FIG. 2) before the vehicle use of the occupant and the image information B of the vehicle cabin inside 20 after the vehicle use of the occupant. It should suffice that the difference C can be detected between the image information A and the image information B, and thus, the disclosure is not limited to the above-described setting.

For example, the difference C may be detected based on information regarding the image information A and the image information B transmitted from the cloud server 14 on the manager side who manages the management server 16 shown in FIG. 7. Furthermore, a setting may be performed such that the image information A and the image information B are transmitted directly from the vehicle 12 to the management server 16.

In the embodiment, although the difference detection unit 110 (see FIG. 9) that detects the difference C is provided in the cloud server 14, the difference detection unit 110 may be provided on the vehicle 12 side.

In addition, in the embodiment, although an example where the image A, the image B, and the difference C (image C) are displayed on the monitor 100 shown in FIG. 7 has been described, it should suffice that the difference C can be detected, and thus, a display method is not particularly limited. For example, a setting may be performed such that the difference C is displayed directly in the image information B by highlighting the difference C between the image information A and the image information B in the image information B (image B), or the like.

In the embodiment, although a setting is performed such that the motors 44, 54 that move (swing) the cameras 28, 32 shown in FIG. 2 are driven by the motor drive signal input to the management server 16, the disclosure is not limited thereto.

For example, the communication unit 104 on the vehicle 12 side receives information regarding the use start time and the use end time of the vehicle 12 from the management server 16, and thus, for example, a setting may be performed such that the motors 44, 54 are automatically driven one hour before the use start time based on information. Note that, in this case, a timer is provided on the vehicle 12 side. For example, in a case where information regarding the use start time of the vehicle 12 is received from the management server 16, a time at which the motors 44, 54 are driven one hour before the use start time is set by the timer.

In the embodiment, although a setting is performed such that the cloud server 14 determines whether or not the vehicle 12 is usable based on the difference detected by the difference detection unit 110, the disclosure is not limited thereto. For example, a setting may be performed such that the manager who manages the vehicle 12 performs the determination based on the image A, the image B, and the image C displayed on the monitor 100.

Note that, in the embodiment, although the camera 28 that images the area in front of the vehicle and the camera 32 that images the area behind the vehicle are provided, both cameras may not always be needed. For example, any one of the camera 28 and the camera 32 may be provided. In particular, the camera 32 primarily images the rear seat 24 side and is thus effective for detecting a thing left behind.

In the embodiment, although the camera 28 is provided on the front windshield 26 side of the vehicle cabin inside 20 and the camera 32 is provided on the rear windshield 30 side of the vehicle cabin inside 20, the disclosure is not limited to the above-described configuration as long as the vehicle cabin inside 20 can be imaged with the cameras 28, 32 that can image the vehicle cabin outside 21. For example, though not shown in the drawing, a camera may be provided on a roof side panel side of the vehicle cabin inside 20.

In the embodiment, although a change, such as a thing left behind, scratch, or dirt, in the vehicle cabin inside 20 due to the use of the vehicle 12 is detected by the function of the difference detection unit 110, the disclosure is not limited thereto, and a configuration may be made in which solely a thing left behind in the vehicle cabin inside 20 is detected. Alternatively, a configuration may be made in which solely scratch or dirt in the vehicle cabin inside 20 is detected by the function of the difference detection unit 110. That is, a configuration may be made in which at least one of a thing left behind, scratch, and dirt in the vehicle cabin inside 20 is detected by the difference detection unit 110.

In the embodiment, although an example where the vehicle 12 is a vehicle that is applied to a car sharing service has been described, the disclosure is not limited thereto, and the vehicle 12 may be used as a vehicle that is applied to an unmanned mobility service, such as an unmanned operation bus.

The processing by the CPU reading and executing software (program) in the above-described embodiment may be executed by various processors other than the CPU. Examples of the processors in this case include a programmable logic device (PLD) capable of changing a circuit configuration after manufacture, such as a field-programmable gate array (FPGA), and a dedicated electric circuit that is a processor having a circuit configuration dedicatedly designed for executing specific processing, such as an application specific integrated circuit (ASIC).

Furthermore, the processing executed by the CPU may be executed by one of various processors or may be executed by a combination of two or more processors (for example, a plurality of FPGAs or a combination of a CPU and an FPGA) of the same type or different types. In addition, the hardware structures of various processors are, more specifically, electric circuits in which circuit elements, such as semiconductor elements, are combined.

In the above-described embodiment, although the storage is used as a recording unit, the disclosure is not limited thereto. For example, a recording medium, such as a compact disk (CD), a digital versatile disk (DVD), or a universal serial bus (USB) memory, may be used as a recording unit. In this case, various programs are stored in the recording medium.

The flow of the processing described in the above-described embodiment is an example, and unneeded steps may be deleted, new steps may be added, or the processing sequence may be altered without departing from the spirit of the disclosure.

In addition, the configurations of each control device, the processing server, and the like described in the above-described embodiment are examples, and may be changed depending on the situation without departing from the spirit of the disclosure.

What is claimed is:

1. A vehicle comprising:
an imaging device provided in a vehicle cabin inside and configured to image a vehicle cabin outside; and
a movement unit configured to enable movement of the imaging device such that a vehicle cabin inside is imageable based on a signal or information received by a communication unit configured to transmit and receive the signal or information to and from an outside of the vehicle.

2. The vehicle according to claim 1, wherein the movement unit includes a motor provided in at least one of a front end portion and a rear end portion in a vehicle front-rear direction in the vehicle cabin inside and configured to make the imaging device swing along the vehicle front-rear direction around a shaft disposed along a vehicle width direction.

3. The vehicle according to claim 2, wherein:
when an occupant is using the vehicle, an imaging area of the imaging device is the vehicle cabin outside; and
in a case where the occupant ends the use of the vehicle, the motor is driven based on the signal or information received by the communication unit and the imaging area of the imaging device is turned to the vehicle cabin inside.

4. The vehicle according to claim 1, further comprising:
a before-vehicle use imaging unit configured to image the vehicle cabin inside with the imaging device to acquire first image information based on the signal or information received by the communication unit before the occupant uses the vehicle; and
an after-vehicle use imaging unit configured to image the vehicle cabin inside with the imaging device to acquire second image information based on the signal or information received by the communication unit after the occupant has used the vehicle.

5. The vehicle according to claim 4, further comprising a difference detection unit configured to detect a difference between the first image information and the second image information.

6. The vehicle according to claim 5, wherein the difference includes at least one of an article, scratch, and dirt.

7. A vehicle cabin inside-outside monitoring system comprising:
the vehicle according to claim 1; and
a server configured to receive, through a network, first image information obtained by imaging a vehicle cabin inside with the imaging device before an occupant uses the vehicle and second image information obtained by imaging the vehicle cabin inside with the imaging device after the occupant has used the vehicle.

8. The vehicle cabin inside-outside monitoring system according to claim 7, wherein the server includes a difference detection unit configured to detect a difference between the first image information and the second image information.

9. The vehicle cabin inside-outside monitoring system according to claim 8, wherein the difference detection unit is configured to create difference image information representing an image that specifies the difference.

10. The vehicle cabin inside-outside monitoring system claim 7, wherein the vehicle is shared by a plurality of users and is used by each user at a different time.
